(19) United States
(12) Patent Application Publication
(10) Pub. No.: US 2021/0132787 A1
(43) Pub. Date: May 6, 2021

(54) INPUT DEVICE OF VEHICLE AND METHOD FOR OPERATING THE SAME

(71) Applicants: HYUNDAI MOTOR COMPANY, Seoul (KR); KIA MOTORS CORPORATION, Seoul (KR)

(72) Inventor: Yean Tae Jung, Seongnam-si (KR)

(21) Appl. No.: 16/863,469

(22) Filed: Apr. 30, 2020

(30) Foreign Application Priority Data
Nov. 5, 2019 (KR) 10-2019-0140541

(51) Int. Cl. G06F 3/0488; B60K 35/00

(52) U.S. Cl. CPC G06F 3/04883; B60K 2370/1438; B60K 2370/146; B60K 35/00

(57) ABSTRACT

An input device of a vehicle according to an embodiment of the present disclosure includes a touch display for recognizing user input, and a controller that recognizes touch information including touch coordinates and the number of touches from the user input, and deforms a shape of the touch display based on the touch information to form deformed manipulation portions having different user set functions.

### CROSS-REFERENCE TO RELATED APPLICATION

This application claims the benefit of priority to Korean Patent Application No. 10-2019-0140541, filed in the Korean Intellectual Property Office on Nov. 05, 2019, the entire contents of which are incorporated herein by reference.

### TECHNICAL FIELD

The present disclosure relates to an input device of a vehicle and a method for operating the same.

### BACKGROUND

A shape display refers to a display device that represents information by physically modifying a unit of a display surface, unlike a conventional display used for displaying an image in a mobile device and the like.

In a field of such shape display, recently, a variable display using a linear cam, a dynamic display system that three-dimensionally deforms an elastic surface using a mechanical actuator array (a pneumatic piston, a connecting node, and the like) provided below a screen, or the like has been introduced.

However, a general shape display does not include a touch display or the like, which performs a function of representing a user's touch input and a plurality of pixels as color information, on a top of a surface display, and only provides the same input scheme and function regardless of a deformed shape of the display surface.

### SUMMARY

The present disclosure has been made to solve the above-mentioned problems occurring in the prior art while advantages achieved by the prior art are maintained intact.

An aspect of the present disclosure provides an input device of a vehicle having a deformed manipulation portion whose shape is changed based on a user's touch information input, and a method for operating the same.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an input device of a vehicle includes a touch display for recognizing user input, and a controller that recognizes touch information including touch coordinates and the number of touches from the user input, and deforms a shape of the touch display based on the touch information to form deformed manipulation portions having different user set functions.

In one embodiment, the controller may control a vertical movement of a deformation member located inside the touch display to form the deformed manipulation portions.

In one embodiment, the touch information may further include a touch time duration.

In one embodiment, the controller may recognize the touch information as first touch information when the number of touches is 1 or 2 and the touch time duration is equal to or greater than a set time duration.

In one embodiment, the controller may protrude one or two surface regions of the touch display corresponding to the one or two touch coordinates from the first touch information to form one or two switch-type deformed manipulation portions on a surface of the touch display.

In one embodiment, the controller may recognize the touch information as second touch information when the number of touches is 3 and the touch time duration is equal to or greater than a set time duration.

In one embodiment, the controller may protrude a surface region of the touch display corresponding to a curve passing through the three touch coordinates from the second touch information to form an inclined face-type deformed manipulation portion on a surface of the touch display.

In one embodiment, the controller may recognize the touch information as third touch information when the number of touches is 5 and the touch time duration is equal to or greater than a set time duration.

In one embodiment, the controller may protrude a surface region of the touch display corresponding to an interior of a circle whose diameter is a line passing through two farthest points among the five touch coordinates from the third touch information to form a hemispherical deformed manipulation portion on a surface of the touch display.

In one embodiment, the controller may implement a graphic user interface (GUI) based on a shape of the deformed manipulation portion on the touch display.

According to an aspect of the present disclosure, a method for operating an input device of a vehicle, includes recognizing user input, recognizing touch information including touch coordinates and the number of touches from the user input, and deforming a shape of the touch display based on the touch information to form deformed manipulation portions having different user set functions.

In one embodiment, the forming of the deformed manipulation portions may include controlling a vertical movement of a deformation member located inside the touch display to form the deformed manipulation portions.

In one embodiment, the touch information may further include a touch time duration.

In one embodiment, the recognizing of the touch information may include recognizing the touch information as first touch information when the number of touches is 1 or 2 and the touch time duration is equal to or greater than a set time duration.

In one embodiment, the forming of the deformed manipulation portions may include protruding one or two surface regions of the touch display corresponding to the one or two touch coordinates to form one or two switch-type deformed manipulation portions on a surface of the touch display when the first touch information is recognized.

In one embodiment, the recognizing of the touch information may include recognizing the touch information as second touch information when the number of touches is 3 and the touch time duration is equal to or greater than a set time duration.

In one embodiment, the forming of the deformed manipulation portions may include protruding a surface region of the touch display corresponding to a curve passing through the three touch coordinates to form an inclined face-type deformed manipulation portion on a surface of the touch display when the second touch information is recognized.

In one embodiment, the recognizing of the touch information may include recognizing the touch information as third touch information when the number of touches is 5 and the touch time duration is equal to or greater than a set time duration.

In one embodiment, the forming of the deformed manipulation portions may include protruding a surface region of the touch display corresponding to an interior of a circle whose diameter is a line passing through two farthest points among the five touch coordinates to form a hemispherical deformed manipulation portion on a surface of the touch display when the third touch information is recognized.

In one embodiment, the method may further include implementing a graphic user interface (GUI) based on a shape of the deformed manipulation portion on the touch display.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating an input device of a vehicle according to one embodiment of the present disclosure;

FIG. 2 is a cross-sectional view illustrating an input device of a vehicle according to one embodiment of the present disclosure;

FIG. 3 is a cross-sectional view illustrating an input device of a vehicle in which a controller is formed below a touch display, according to another embodiment of the present disclosure;

FIGS. 4A, 4B, 4C, and 4D are perspective views illustrating an embodiment of forming a switch-type deformed manipulation portion of an input device of a vehicle according to one embodiment of the present disclosure;

FIGS. 5A, 5B, and 5C are perspective views illustrating an embodiment of forming an inclined face-type deformed manipulation portion of an input device of a vehicle according to one embodiment of the present disclosure;

FIGS. 6A, 6B, and 6C are perspective views illustrating an embodiment of forming a hemispherical deformed manipulation portion of an input device of a vehicle according to one embodiment of the present disclosure;

FIG. 7 is a flowchart illustrating a method for operating an input device of a vehicle according to one embodiment of the present disclosure;

FIG. 8 is a flowchart illustrating a method for recognizing first, second, and third touch information in a method for operating an input device of a vehicle according to one embodiment of the present disclosure;

FIG. 9 is a view illustrating a graphical user interface of a switch-type deformed manipulation portion according to one embodiment of the present disclosure;

FIG. 10 is a view illustrating a graphical user interface when there are two switch-type deformed manipulation portions, according to one embodiment of the present disclosure;

FIG. 11 is a view illustrating a graphical user interface of an inclined face-type deformed manipulation portion according to one embodiment of the present disclosure;

FIG. 12 is a diagram illustrating a graphical user interface of a hemispherical deformed manipulation portion according to one embodiment of the present disclosure; and

FIG. 13 is a view for illustrating user set function operations of switch-type deformed manipulation portions according to one embodiment of the present disclosure.

### DETAILED DESCRIPTION

Hereinafter, embodiments of the present disclosure will be described in detail with reference to the accompanying drawings. The embodiments to be introduced below are only presented to sufficiently convey the idea of the present disclosure to those skilled in the art to which the present disclosure pertains, and the present disclosure is not limited to the embodiments presented. The present disclosure may also be embodied in other embodiments. In order to clarify the present disclosure, the drawings may omit parts of the description which are not related to the description, and may exaggerate the size and the like of the components to help understanding.

The present disclosure discloses content about an input device of a vehicle, but the input device is not necessarily limited to be used in the vehicle. The present disclosure may be used for various input devices such as a mobile phone with a touch display, a smart phone, a laptop computer, a terminal for digital broadcasting, a PDA (personal digital assistant), a navigation, a slate PC, a tablet PC, a ultrabook, a wearable device, a KIOSK, and the like, as similar input devices.

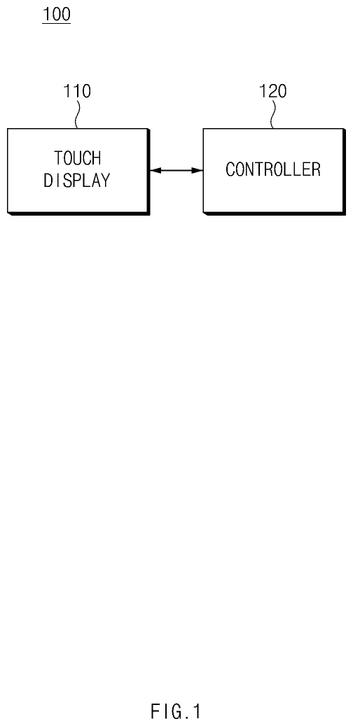

FIG. 1 is a view illustrating an input device of a vehicle according to one embodiment of the present disclosure.

Referring to FIG. 1, an input device 100 of a vehicle may include a touch display 110 and a controller 120.

The touch display 110 may receive an input from a user. Hereinafter, the user input will be assumed as a touch input. The touch display 110 may recognize the user input. The controller 120 may recognize touch information from the user input. The touch information may include touch coordinates and the number of touches, and in some embodiments, the touch information may further include a touch time duration in addition to the touch coordinates and the number of touches.

In this connection, the touch coordinates may mean physical coordinates of the user input received on the touch display 110. The number of touches may mean the number of user inputs (that is, how many touch inputs there are). The touch time duration may mean a time duration for which the user input is maintained or a touch duration of the user input with respect to the touch display 110.

When the touch time duration is equal to or greater than a set time duration, the controller 120 may divide the touch information recognized through the touch display into first touch information, second touch information, and third touch information based on the number of touches.

When the number of touches is 1 or 2 and the touch time duration is equal to or greater than the set time duration, the controller 120 may recognize the touch information as the first touch information. When the number of touches is 3 and the touch time duration is equal to or greater than the set time duration, the controller 120 may recognize the touch information as the second touch information. When the number of touches is 5 and the touch time duration is equal to or greater than the set time duration, the controller 120 may recognize the touch information as the third touch information. Each of the first touch information, the second touch information, and the third touch information may include the touch coordinate, the number of touches, and the touch time duration. The controller 120 may form a deformed manipulation portion based on the first to third touch information.

The touch display 110 may be a capacitive or resistive touch display, and may output a graphic user interface. Further, when a shape of the touch display 110 may be changed, there is no limit in a material and an operation scheme of the touch display 110.

The controller 120 may control the touch display 110 based on the touch information recognized from the user input. For example, the controller 120 may deform the shape of the touch display 110 based on the first to third touch information to form deformed manipulation portions having different user set functions.

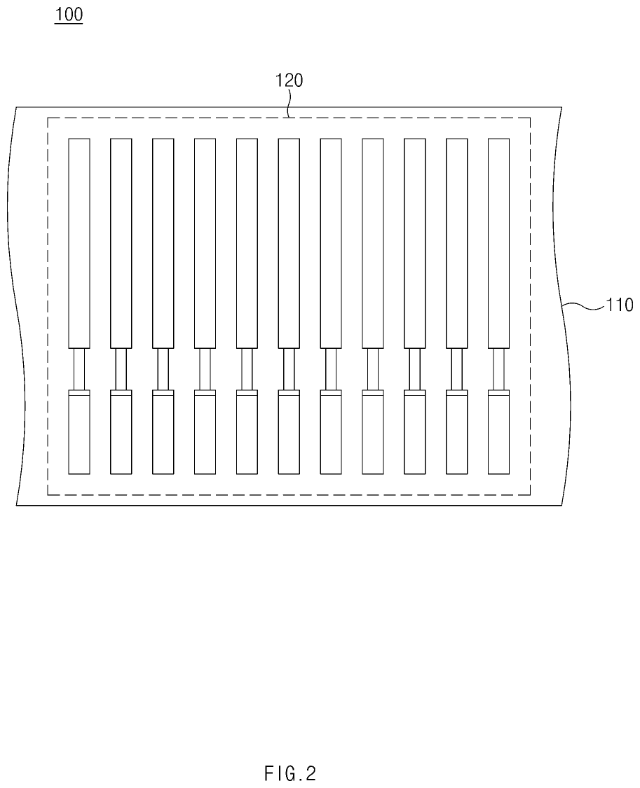

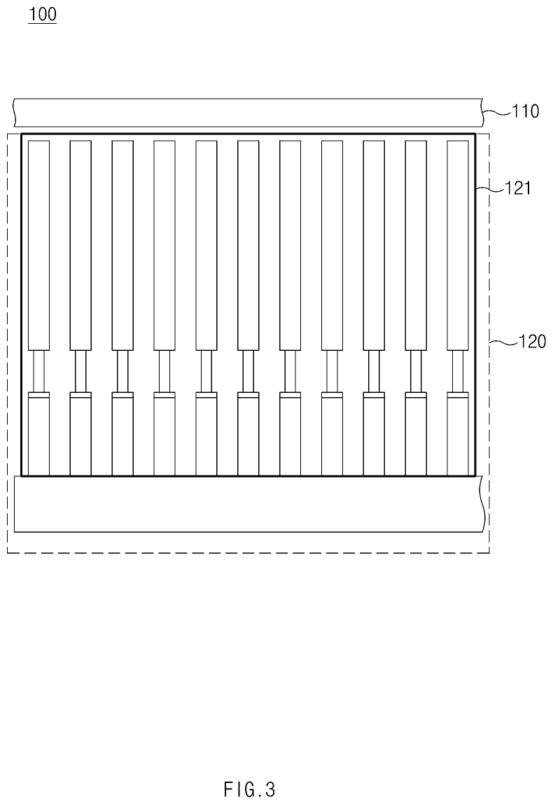

The controller 120 may form the deformed manipulation portion by controlling a vertical movement of a deformation member located inside the touch display 110 based on the touch information. This will be described in detail with reference to FIGS. 2 and 3 below.

The controller 120 may protrude one or two surface regions of the touch display 110 of one or two coordinates corresponding to one or two touch coordinates of the first touch information from the first touch information to form one or two switch-type deformed manipulation portions on a surface of the touch display 110.

The controller 120 may protrude a surface region of the touch display 110 of coordinates corresponding to a curve passing through all touch coordinates of the second touch information from the second touch information to form an inclined face-type deformed manipulation portion on the surface of the touch display 110.

The controller 120 may protrude a surface region of the touch display 110 of coordinates corresponding to an interior of a circle whose diameter is a line passing through the two farthest points among touch coordinates of the third touch information from the third touch information to form a hemispherical deformed manipulation portion on the surface of the touch display 110.

The controller 120 forms the deformed manipulation portions having different user set functions depending on the touch information. The user set function may be various functions such as an air conditioner inside the vehicle, AVN (audio, video, navigation), internal lighting, and the like. When the user set function is a function that may be performed by the input device of the vehicle, the user set function is not limited to the above-described functions. That is, the deformed manipulation portion may be utilized as a manipulation button for the user set function.

As described above, when there is the user input on the touch display 110, the controller 120 may recognize the touch information, and then change the surface shape of the touch display 110 of the vehicle, so that the deformed manipulation portion may be formed. The controller 120 implements a graphic user interface on the surface of the touch display 110 based on the shape of the formed deformed manipulation portion. Thus, unlike general flat input devices, the user may easily manipulate the touch display 110 even in a situation where a manipulation system cannot be visually seen. In addition, the deformed manipulation portion may increase user convenience by providing a manipulation feeling familiar to the user.

FIG. 2 is a cross-sectional view illustrating an input device of a vehicle according to one embodiment of the present disclosure.

Referring to FIG. 2, the controller 120 may be disposed inside the touch display 110. According to one embodiment shown in FIG. 2, the controller 120 may control the touch display 110 using individual actuators. In this connection, the actuator may mean a driving apparatus using electricity, hydraulic pressure, compressed air, or the like, and may be used as a term collectively referring to a mechanical apparatus used to move or control a system. Entire actuators may be seen as one controller, and the controller may be divided into individual actuators (control modules).

FIG. 3 is a cross-sectional view illustrating an input device of a vehicle in which a controller is formed below a touch display, according to another embodiment of the present disclosure.

Referring to FIG. 3, the controller 120 may be disposed below the touch display 110, and the controller 120 may include a deformation member 121. The deformation member may operate in an electronic or mechanical control scheme, which is not necessarily limited to the embodiment.

In FIGS. 2 and 3, the deformation member 121 of the controller 120 may be the actuator. In this connection, the controller 120 may control the surface shape of the touch display 110 through contraction and relaxation of the deformation member 121. The deformation member 121 is not necessarily limited to the actuator, and any configuration may be selected as long as it may deform the surface shape of the touch display 110. As an embodiment of the deformation member, a drive gear or an elastic member such as a spring and the like may also be used. Further, pneumatic and electronic actuators and the like may also be selected. However, for convenience of understanding, the deformation member 121 will be described as being assumed as the pneumatic actuator shown in FIG. 3.

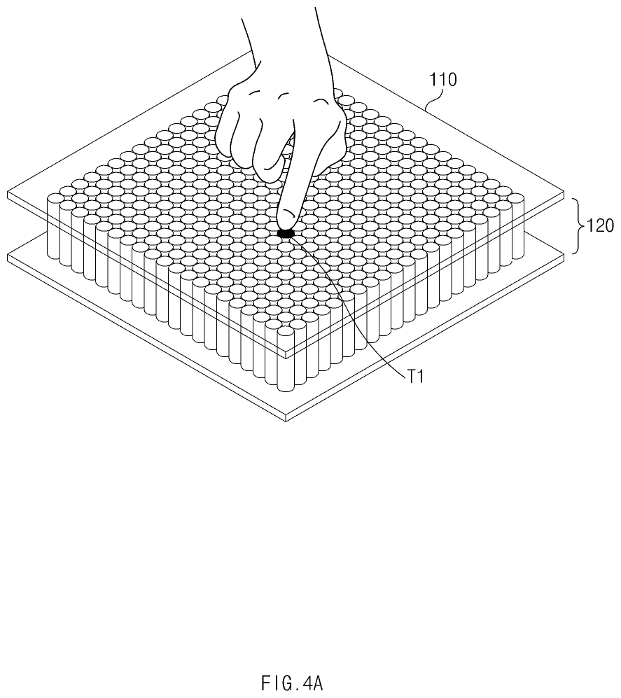

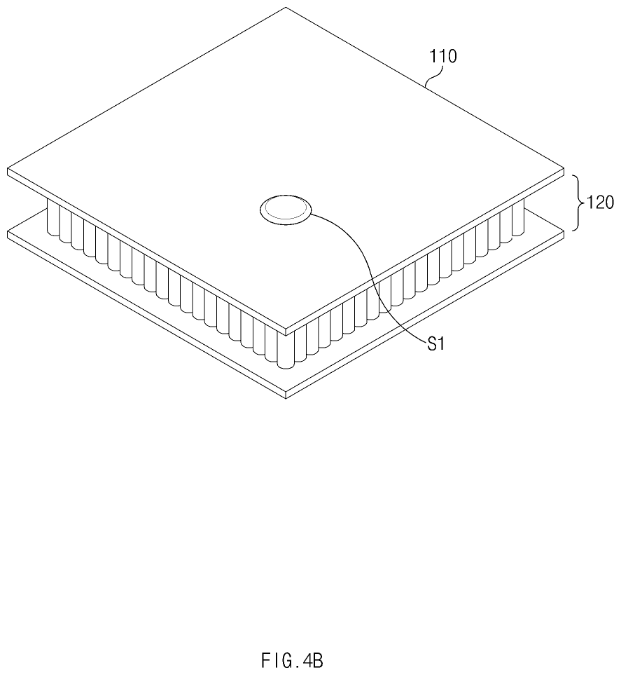

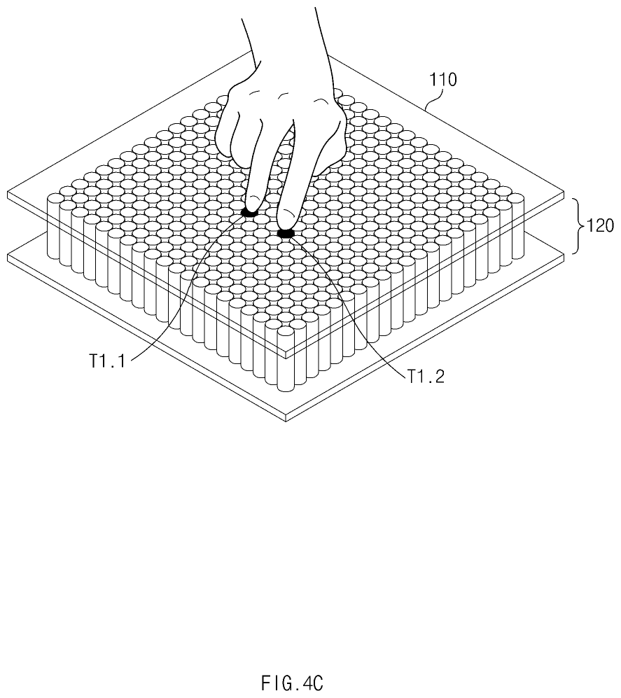

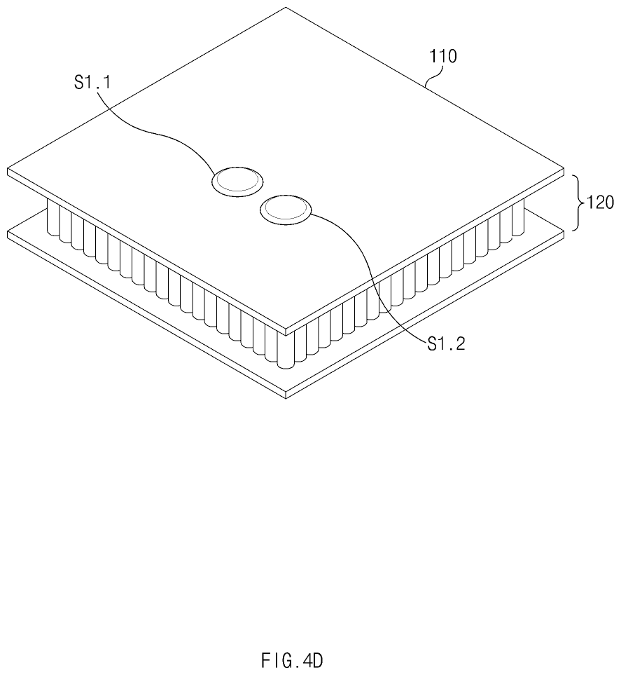

FIGS. 4A, 4B, 4C, and 4D are views for illustrating a process of forming, by the controller 120, a switch-type deformed manipulation portion(s) S1 or S1.1 and S1.2 of the present disclosure. When the user input on the touch display 110 has the touch time duration equal to or greater than the set time duration, and the number of touches is 1 or 2, the controller 120 may recognize touch information based on the corresponding user input as the first touch information so that the switch-type deformed manipulation portion(s) S1 or S1.1, and S1.2 may be formed.

Referring to FIGS. 4A and 4C, when the number of touches is 1 or 2, and the touch time duration is equal to or greater than the set time duration, the controller 120 may recognize the touch information as the first touch information. FIG. 4A illustrates a position corresponding to a touch coordinate T1 of the first touch information.

Referring to FIG. 4B, the controller 120 may protrude a region of the touch display 110 at a position corresponding to the touch coordinate T1 using the first touch information to form a switch-type deformed manipulation portion S1.

Referring to FIGS. 4C and 4D, the controller 120 may protrude surface regions of the touch display 110 at a position corresponding to touch coordinates T1.1 and T1.2 to form the switch-type deformed manipulation portions S1.1 and S1.2.

A function of the switch-type deformed manipulation portion Si or S1.1 or S1.2 may vary depending on user's setting. The switch-type deformed manipulation portion S1 or S1.1 or S1.2 may be typically used as an on/off manipulation button of vehicle internal apparatuses and the like, but is not necessarily limited thereto.

A height, a size, a spacing, a manipulation function, and the like of the switch-type deformed manipulation portion S1 or S1.1 or S1.2 may be arbitrarily set by the user. In one embodiment, the switch-type deformed manipulation portion S1 or S1.1 or S1.2 may be used as a power switch of a navigation for the vehicle or the like.

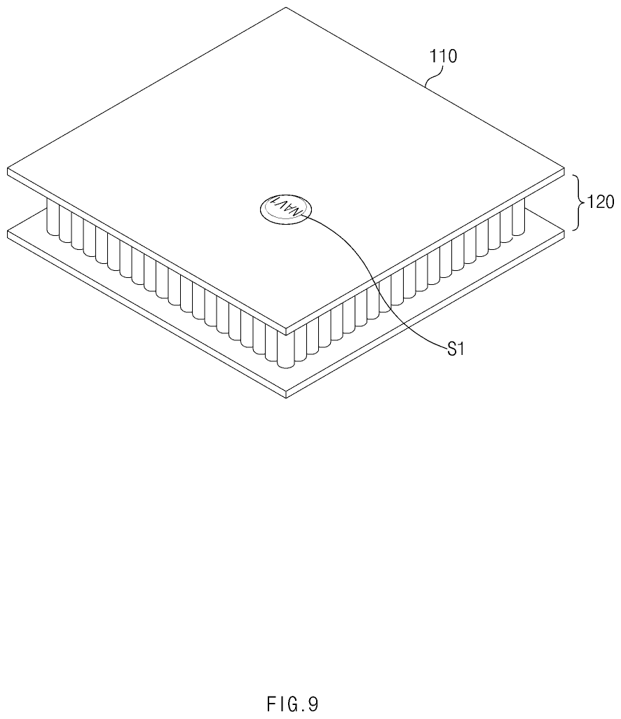

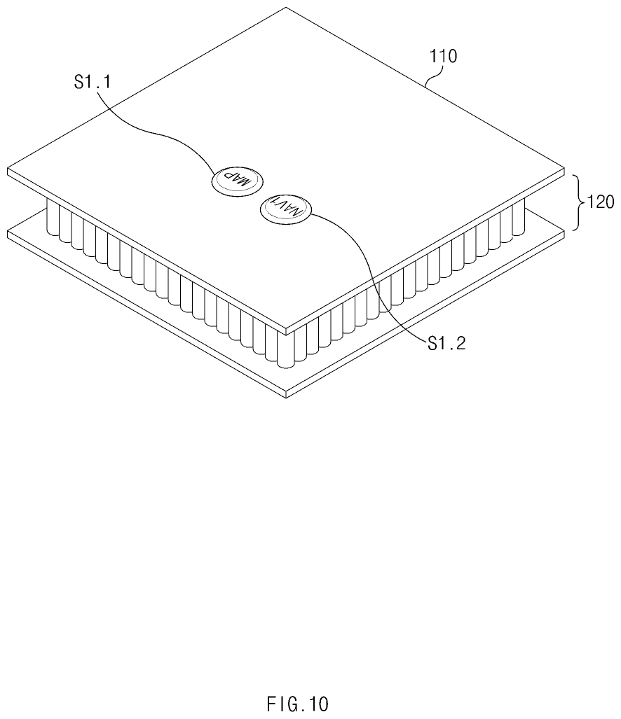

As the switch-type deformed manipulation portion(s) S1 or S1.1 and S1.2 are formed, the user may utilize the input device 100 of the present vehicle as an input device for a preset function. As the deformed manipulation portion is formed, the controller 120 may output a separate graphic user interface on the touch display 110 to assist the user in utilizing the input device. Specific embodiments thereof will be described in detail with reference to FIGS. 9 and 10.

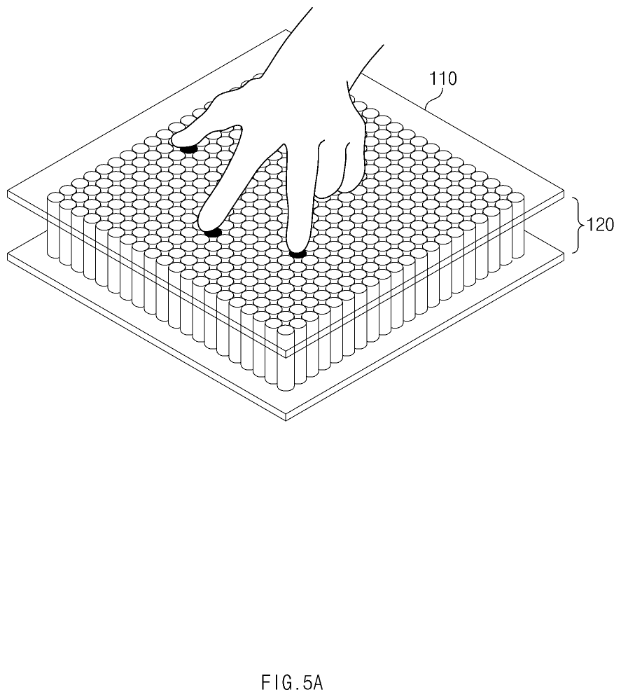

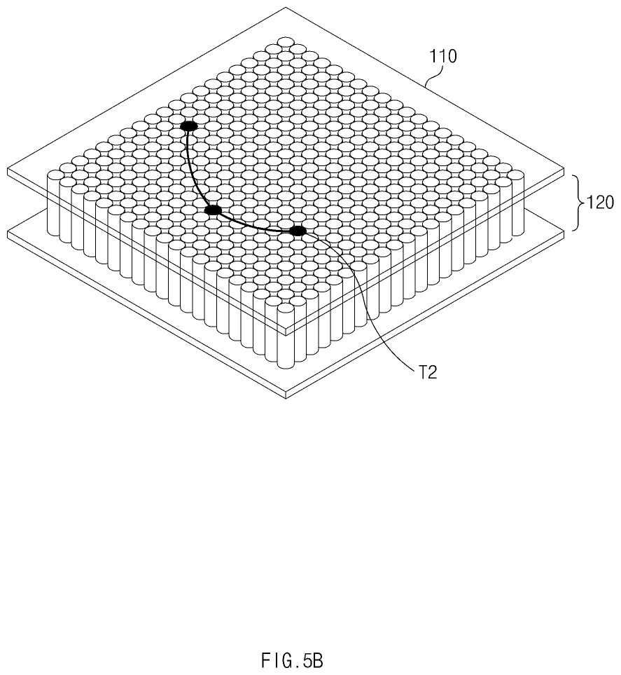

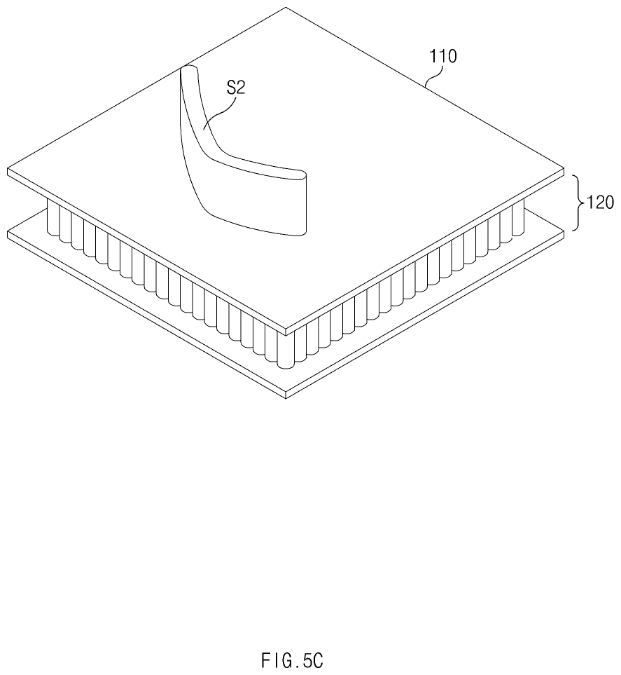

FIGS. 5A to 5C are views for illustrating an inclined face-type deformed manipulation portion S2 of the present disclosure. When the user input on the touch display 110 has a touch time duration equal to or greater than the set time duration, and the number of touches is 3, the controller 120 may recognize touch information based on the corresponding user input as the second touch information to form the inclined face-type deformed manipulation portion S2.

Referring to FIG. 5A, when the number of touches is 3 and the touch time duration is equal to or greater than the set time duration, the controller 120 may recognize the touch information as the second touch information.

Referring to FIG. 5B, touch coordinates of the second touch information recognized from the user input, and coordinates corresponding to a trajectory T2 of an arbitrary curve passing through all of the corresponding touch coordinates are illustrated. As an example of specifying such a curve, an arc of a circle passing through all three touch coordinates may be assumed.

Referring to FIG. 5C, the controller 120 may protrude a surface region of the touch display 110 at a position corresponding to the coordinates shown in FIG. 5B to form the inclined face-type deformed manipulation portion S2.

A function of the inclined face-type deformed manipulation portion S2 may vary depending on user's setting. The inclined face-type deformed manipulation portion S2 may be typically used to manipulate output and frequency of a vehicle internal device, but is not necessarily limited thereto.

A size, a height, an angle, a degree of protrusion, and the function of the inclined face-type deformed manipulation portion S2 may be arbitrarily set by the user. In one embodiment, the inclined face-type deformed manipulation portion S2 may be used as a volume control input device of a speaker inside the vehicle, a temperature control input device of the air conditioner for the vehicle, and the like.

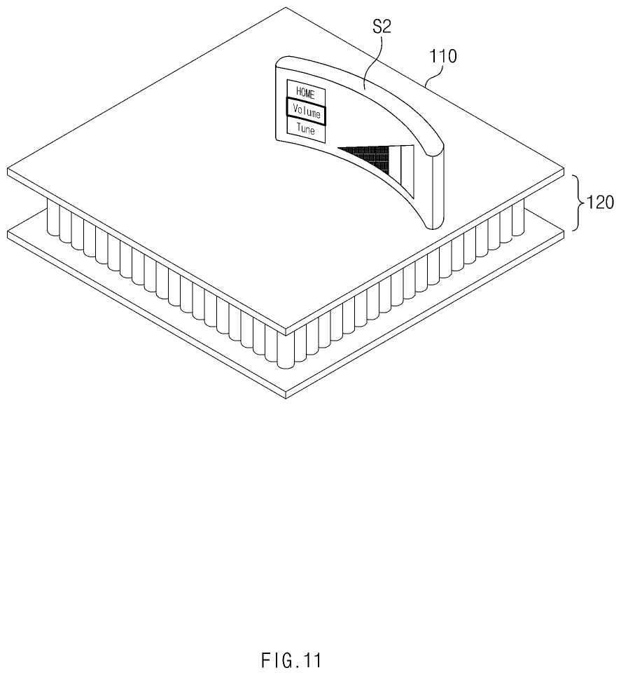

As the inclined face-type deformed manipulation portion S2 is formed, the user may utilize the input device 100 of the present vehicle as an input device for a preset function. As the deformed manipulation portion is formed, the controller 120 may output a separate graphic user interface on the touch display 110 to assist the user in utilizing the input device. Specific embodiments thereof will be described in detail with reference to FIG. 11.

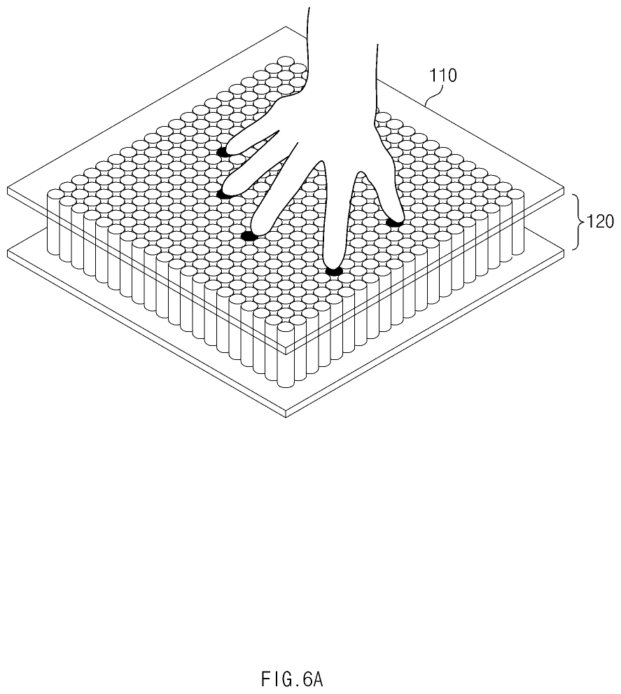

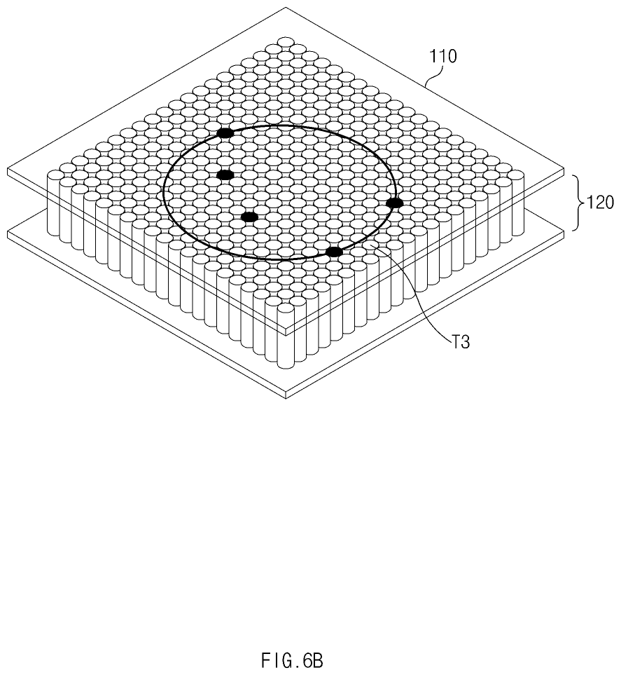

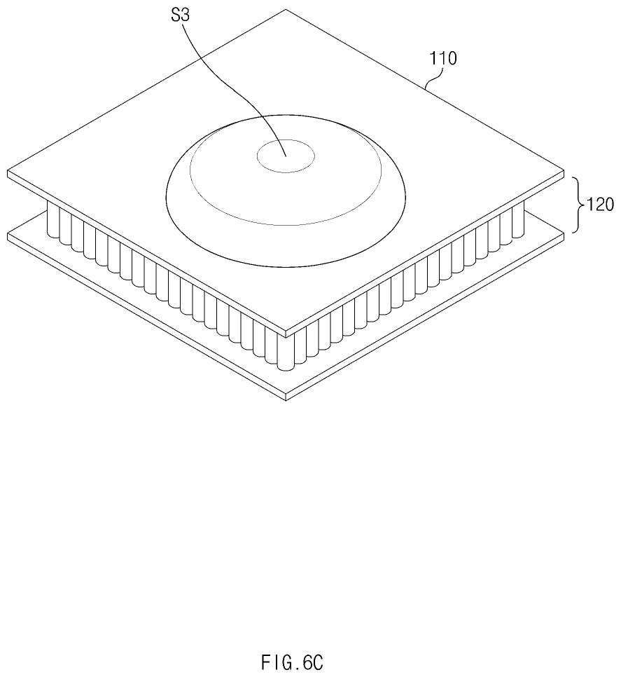

FIGS. 6A, 6B, and 6C are views for illustrating a hemispherical deformed manipulation portion S3 of the present disclosure. When the user input on the touch display 110 has a touch time duration equal to or greater than the set time duration, and the number of touches is 5, the controller 120 may recognize touch information based on the corresponding user input as the third touch information to form the hemispherical deformed manipulation portion S3.

Referring to FIG. 6A, when the number of touches is 5 and the touch time duration is equal to or greater than the set time duration, the controller 120 may recognize the touch information as the third touch information.

Referring to FIG. 6B, touch coordinates of the third touch information recognized from the user input, and coordinates corresponding to a trajectory T3 of a circle whose diameter is a line passing through the two farthest points among the corresponding touch coordinates are shown.

Referring to FIG. 6C, the controller 120 may protrude a surface region of the touch display 110 at a position corresponding to coordinates inside the circle using the third touch information to form the hemispherical deformed manipulation portion S3. Such circle is not necessarily limited to embodiment. The hemispherical deformed manipulation portion S3 may be formed by protruding a surface region of the touch display 110 at a position corresponding to coordinates of a circle included in the T3.

A function of the hemispherical deformed manipulation portion S3 may vary depending on user's setting. The hemispherical deformed manipulation portion S3 may be typically used as a device for turning on/off the AVN (audio, video, navigation) device inside the vehicle or selecting a desired content from a specific list, but is not necessarily limited thereto.

A height, a size, a spacing, and a function of the hemispherical deformed manipulation portion S3 may be set arbitrarily by the user. In one embodiment, the hemispherical deformed manipulation portion S3 may be used to perform a ‘wheel function’ through the touch display when a periphery thereof is manipulated in a turning manner, and may be used to perform a ‘selection switch function’ when a protruding top is touched. An example of utilization of the hemispherical deformed manipulation portion may include a manipulation device of a radio for a vehicle and the like.

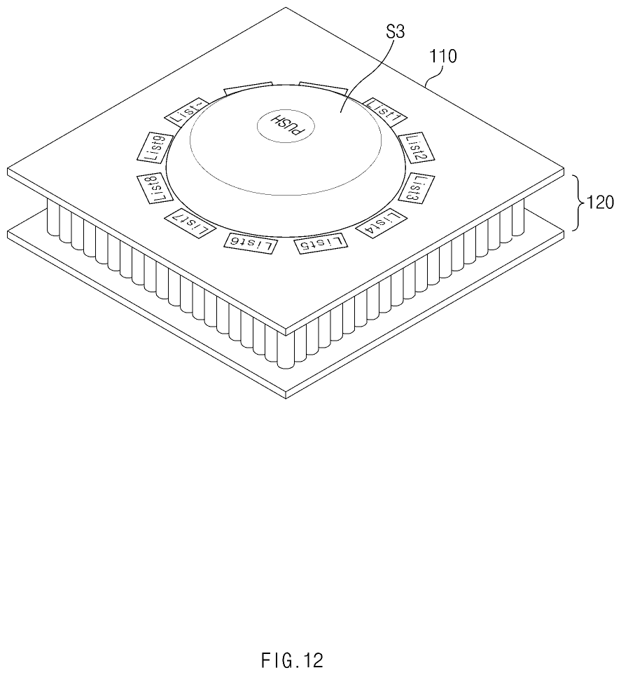

As the hemispherical deformed manipulation portion S3 is formed, the user may utilize the input device 100 of the present vehicle as an input device for a preset function. As the deformed manipulation portion is formed, the controller 120 may output a separate graphic user interface on the touch display 110 to assist the user in utilizing the input device. A specific embodiment thereof will be described in detail with reference to FIG. 12.

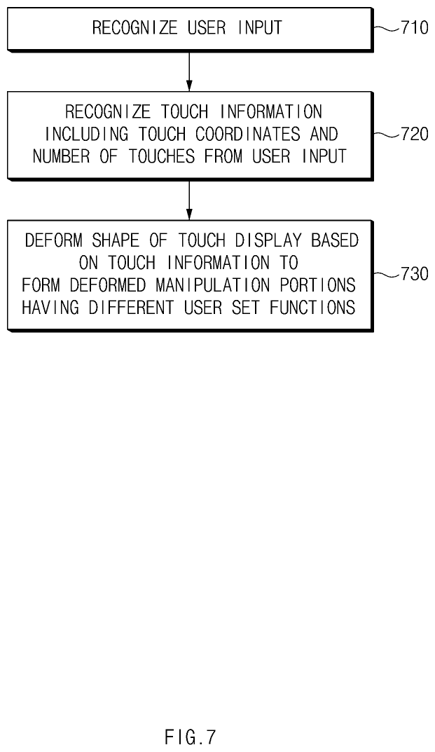

FIG. 7 is a flowchart illustrating a method for operating an input device of a vehicle according to one embodiment of the present disclosure.

Referring to FIG. 7, a method for operating an input device of a vehicle according to one embodiment of the present disclosure may include recognizing the user input 710, recognizing 720 the touch information including the touch coordinates and the number of touches from the user input, and deforming 730 the shape of the touch display 110 based on the touch information to form the deformed manipulation portions having the different user set functions.

Hereinafter, the operations 710 to 720 are described with reference to FIG. 1.

In operation 710, the touch display 110 may recognize the user input. The controller 120 may recognize the touch information including the touch coordinates and the number of touches from the user input. In some embodiments, the touch information may further include the touch time duration in addition to the touch coordinates and the number of touches. When the touch time duration is equal to or greater than the set time duration, the controller 120 may recognize the touch information as the first touch information, the second touch information, or the third touch information depending on the number of touches.

When the number of touches is 1 or 2 and the touch time duration is equal to or greater than the set time duration, the controller 120 may recognize the touch information as the first touch information. When the number of touches is 3 and the touch time duration is equal to or greater than the set time duration, the controller 120 may recognize the touch information as the second touch information. When the number of touches is 5 and the touch time duration is equal to or greater than the set time duration, the controller 120 may recognize the touch information as the third touch information. Each of the first touch information, the second touch information, and the third touch information may include the touch coordinates, the number of touches, and the touch time duration information.

In operation 720, the controller 120 may recognize the touch information based on the user input on the touch display 110.

In operation 730, the controller 120 may control the touch display 110 based on the recognized touch information. For example, the controller 120 may deform the shape of the touch display 110 based on the first to third touch information to form the deformed manipulation portions having the different user set functions based on the touch information. For example, the controller 120 may control the vertical movement of the deformation member located inside the touch display 110 based on the touch information to form the deformed manipulation portion.

When the first touch information is recognized, the controller 120 may protrude one or two surface regions of the touch display 110 corresponding to one or two touch coordinates of the first touch information to form one or two switch-type deformed manipulation portions on the surface of the touch display 110. When the second touch information is recognized, the controller 120 may protrude the surface region of the touch display 110 corresponding to the curve passing through all of the touch coordinates of the second touch information to form the inclined face-type deformed manipulation portion on the surface of the touch display 110.

When the third touch information is recognized, the controller 120 may protrude the surface region of the touch display 110 corresponding to the interior of the circle whose diameter is the line passing through the two farthest points among the touch coordinates of the third touch information to form the hemispherical deformed manipulation portion on the surface of the touch display 110.

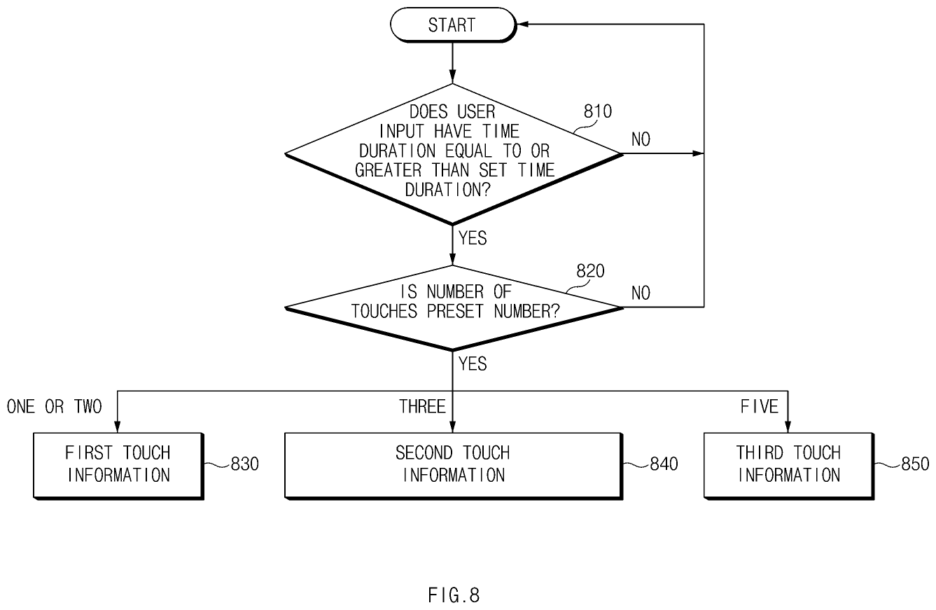

FIG. 8 is a flowchart illustrating a method for recognizing first, second, and third touch information in a method for operating an input device of a vehicle according to one embodiment of the present disclosure.

Referring to FIG. 8, the operation 720 of FIG. 7 in the method for operating the input device of the vehicle according to an embodiment of the present disclosure may be described in detail.

In the following, operations 810 to 850 are described with reference to FIGS. 4A to 6C.

The controller 120 may recognize the touch information from the user input. The recognizing of the touch information (720) begins with determining (810) whether the user input has a time duration equal to or greater than the set time duration. When the input does not have the time duration equal to or greater than the set time duration, the controller 120 may initiate the determination of the touch information again when there is a new user input. When the input has the time duration equal to or greater than the set time duration, the controller 120 may proceed to determining the number of touches.

In operation 820, the controller 120 may determine whether to recognize each touch information based on the preset number of touches. When the number of touches is not the preset number, the controller 120 may initiate the determination of the touch information again when there is a new user input. When the number of touches is the preset number, the controller 120 may recognize the touch information including the number of touches and the touch coordinates based on each of the number of touches. In this connection, in some embodiments of the present disclosure, the touch information may further include the touch time duration.

Operations 830 to 850 illustrate a process of recognizing the first to third touch information according to an embodiment of the present disclosure.

In operation 830, when there is the input having the touch time duration equal to or greater than the set time duration, and the number of touches is 1 or 2, the controller 120 may recognize the touch information based on the corresponding input as the first touch information including one or two touch coordinates T1 or T1.1 and T1.2, the number of touches, and the touch time duration.

In operation 840, when there is the input having the touch time duration equal to or greater than the set time duration, and the number of touches is 3, the controller 120 may recognize the touch information based on the input as the second touch information including the touch coordinates, the number of touches, and the touch time duration. The second touch information may include the coordinate information corresponding to the trajectory T2 of the curve passing through all the touch coordinates.

In operation 850, when there is the input having the touch time duration equal to or greater than the set time duration and the number of touches is 5, the controller 120 may recognize the touch information based on the corresponding input as the third touch information including the touch coordinates, the number of touches, and the touch time duration. The third touch information may include the coordinate information corresponding to the trajectory T3 of the circle whose diameter is the line passing through the two most remote points among the touch coordinates.

The controller 120 may deform the surface shape of the touch display 110 using the first, second, and third touch information recognized according to the operations 810 to 850.

FIG. 9 is a view illustrating a graphical user interface of the switch-type deformed manipulation portion S1 according to one embodiment of the present disclosure.

Referring to FIG. 9, the controller 120 may output a graphic user interface on the touch display 110 as the switch-type deformed manipulation portion S1 is formed. As an embodiment, the controller 120 may output a navigation NAV1 button as the graphical user interface for the switch-type deformed manipulation portion S1. The graphic user interface may improve the user's manipulation convenience, and may assist the manipulation of the switch-type deformed manipulation portion S1.

FIG. 10 is a view illustrating a graphical user interface when there are two switch-type deformed manipulation portions S1.1 and S1.2, according to one embodiment of the present disclosure.

Referring to FIG. 10, the controller 120 may output a graphic user interface on the touch display 110 as the switch-type deformed manipulation portions S1.1 and S1.2 are formed. As an embodiment, the controller 120 may output navigation NAV1 and map MAP buttons as the graphic user interface for the switch-type deformed manipulation portions S1.1 and S1.2. The graphic user interface may improve the manipulation convenience of the user and may assist the manipulation of the switch-type deformed manipulation portions S1.1 and S1.2.

When the switch-type deformed manipulation portions Si and S1.1 and S1.2 are formed, in addition to the navigation and map buttons, a graphical user interface, such as ‘hot keys’, ‘favorites’, ‘set function keys with high use frequency’ based on user setting, or the like may be output by the controller 120 on the touch display 110.

FIG. 11 is a view illustrating a graphical user interface of the inclined face-type deformed manipulation portion S2 according to one embodiment of the present disclosure.

Referring to FIG. 11, the controller 120 may output a graphic user interface on the touch display 110 as the inclined face-type deformed manipulation portion S2 is formed. As an embodiment, the controller 120 may output a volume manipulation button (Volume) and the like of the audio for the vehicle as the graphic user interface for the inclined face-type deformed manipulation portion S2. The graphic user interface may improve the user's manipulation convenience, and may assist the manipulation of the inclined face-type deformed manipulation portion S2.

When the inclined face-type deformed manipulation portion S2 is formed, in addition to the volume manipulation button (Volume), a graphic user interface having scroll and slide functions suitable for curved surface manipulation may be output on the touch display 110 by the controller 120.

FIG. 12 is a diagram illustrating a graphical user interface of the hemispherical deformed manipulation portion S3 according to one embodiment of the present disclosure.

Referring to FIG. 12, the controller 120 may output a graphic user interface on the touch display 110 as the hemispherical deformed manipulation portion S3 is formed. As an embodiment, the controller 120 may output an audio track list (List), a select button (PUSH), and the like of the vehicle as the graphic user interface for the hemispherical deformed manipulation portion S3. The graphic user interface may improve the user's manipulation convenience, and may assist in the manipulation of the hemispherical deformed manipulation portion S3.

When the hemispherical deformed manipulation portion S3 is formed, in addition to the audio track list (List) and the select button (PUSH), a graphic user interface suitable for scroll type manipulation and a graphic user interface suitable for selection function manipulation may be respectively output at an outer portion and a central portion of the hemispherical deformed manipulation portion on the touch display 110 by the controller 120.

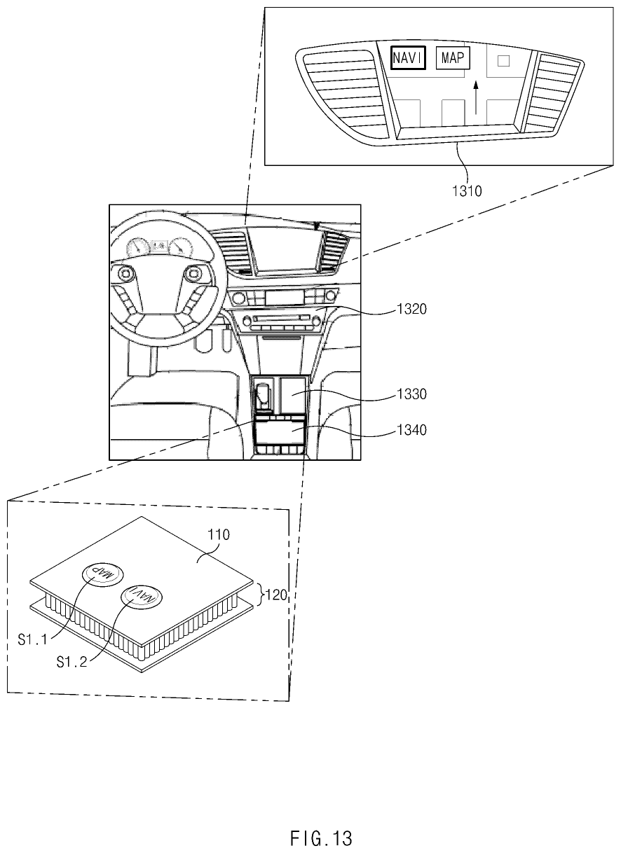

FIG. 13 is a view for illustrating user set function operations of the switch-type deformed manipulation portions S1.1 and S1.2 according to one embodiment of the present disclosure.

Referring to FIG. 13, the input device of the vehicle of the present disclosure may be located on a vehicle air conditioner manipulation unit 1320, a space between a driver's seat and a passenger seat 1330, a gearbox 1340, or the like. FIG. 13 illustrates a case in which a navigation is output on a screen 1310 of the AVN (audio, video, navigation) device, when the input device of the vehicle of the present disclosure is located on the gearbox space 1340 and the switch-type deformed manipulation portions S1.1 and S1.2 are formed, as an embodiment.

When there is no user input for a predetermined time after the deformed manipulation portion is formed, or when the user set operation is performed, the deformed manipulation portion may be deactivated under control of the controller 120, and the touch display 110 may return to a flat shape.

The features, structures, effects, and the like illustrated in the description of the deformed manipulation portion are to be included in one embodiment of the present disclosure, and the functions of the input device of the present disclosure are not necessarily limited to such embodiment. Furthermore, the features, structures, effects, and the like described in such embodiment may be combined with each other or modified by those skilled in the art having ordinary knowledge in the field and the like to which the present disclosure pertains. Therefore, when the features, structures, effects, and the like are based on such combinations and modifications, it should be interpreted as being included in the scope of the present disclosure.

In addition, although, it has been described above mainly with respect to the switch-type, inclined face-type, and hemispherical deformed manipulation portions, these are merely examples and do not limit the present disclosure to only three types of the deformed manipulation portions. Those skilled in the art to which the present disclosure pertains will appreciate that various modifications and applications which are not illustrated may be made without departing from the essential characteristics of the present embodiment.

In addition, the user input for forming the deformed manipulation portion is also not necessarily limited to the embodiment. As an embodiment, a scheme of inputting information of touch coordinates corresponding to an arbitrary straight line or a curve, the number of touches, and a touch time duration into an input unit within a set touch time duration may be assumed. In this connection, as an example, a touch display surface corresponding to the input touch coordinates of the straight line to the curve may be protruded to form a deformed manipulation portion similar to the ‘inclined face-type deformed manipulation portion’. Similarly, other manipulation modes may also be activated based on different input information than in the embodiment.

That is, since each component specifically shown in the embodiment may be modified and implemented, differences associated with such modifications and applications should be interpreted as being included in the scope of the present disclosure defined in the appended claims.

According to the input device of the vehicle and the method for operating the same according to one embodiment of the present disclosure, the deformed manipulation portion of the input device changes based on the changed shape of the touch display, and different function is performed based on the changed deformed manipulation portion, so that a manipulation convenience may be achieved and the user may perform an accurate manipulation even in a situation where a manipulation system cannot be visually seen.

The shape of the deformed manipulation portion of the input device of the vehicle according to an embodiment of the present disclosure may implement manipulation schemes, which may not be implemented in a simple flat input device, with a switch, a scroll, a physical wheel, and the like.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An input device of a vehicle, the input device comprising:
a touch display for recognizing user input; and
a controller configured to recognize touch information including touch coordinates and the number of touches from the user input, and deform a shape of the touch display based on the touch information to form deformed manipulation portions having different user set functions.

2. The input device of claim 1, wherein the controller is configured to control a vertical movement of a deformation member located inside the touch display to form the deformed manipulation portions.

3. The input device of claim 1, wherein the touch information further includes a touch time duration.

4. The input device of claim 3, wherein the controller is configured to recognize the touch information as first touch information when the number of touches is 1 or 2 and the touch time duration is equal to or greater than a set time duration.

5. The input device of claim 4, wherein the controller is configured to protrude one or two surface regions of the touch display corresponding to the one or two touch coordinates from the first touch information to form one or two switch-type deformed manipulation portions on a surface of the touch display.

6. The input device of claim 3, wherein the controller is configured to recognize the touch information as second touch information when the number of touches is 3 and the touch time duration is equal to or greater than a set time duration.

7. The input device of claim 6, wherein the controller is configured to protrude a surface region of the touch display corresponding to a curve passing through the three touch coordinates from the second touch information to form an inclined face-type deformed manipulation portion on a surface of the touch display.

8. The input device of claim 3, wherein the controller is configured to recognize the touch information as third touch information when the number of touches is 5 and the touch time duration is equal to or greater than a set time duration.

9. The input device of claim 8, wherein the controller is configured to protrude a surface region of the touch display corresponding to an interior of a circle whose diameter is a line passing through two farthest points among the five touch coordinates from the third touch information to form a hemispherical deformed manipulation portion on a surface of the touch display.

10. The input device of claim 1, wherein the controller is configured to implement a graphic user interface (GUI) based on a shape of the deformed manipulation portion on the touch display.

11. A method for operating an input device of a vehicle, the method comprising:
recognizing user input;
recognizing touch information including touch coordinates and the number of touches from the user input; and
deforming a shape of the touch display based on the touch information to form deformed manipulation portions having different user set functions.

12. The method of claim 11, wherein the forming of the deformed manipulation portions includes:
controlling a vertical movement of a deformation member located inside the touch display to form the deformed manipulation portions.

13. The method of claim 11, wherein the touch information further includes a touch time duration.

14. The method of claim 13, wherein the recognizing of the touch information includes:
recognizing the touch information as first touch information when the number of touches is 1 or 2 and the touch time duration is equal to or greater than a set time duration.

15. The method of claim 14, wherein the forming of the deformed manipulation portions includes:
protruding one or two surface regions of the touch display corresponding to the one or two touch coordinates to form one or two switch-type deformed manipulation portions on a surface of the touch display when the first touch information is recognized.

16. The method of claim 13, wherein the recognizing of the touch information includes:
recognizing the touch information as second touch information when the number of touches is 3 and the touch time duration is equal to or greater than a set time duration.

17. The method of claim 16, wherein the forming of the deformed manipulation portions includes:
protruding a surface region of the touch display corresponding to a curve passing through the three touch coordinates to form an inclined face-type deformed manipulation portion on a surface of the touch display when the second touch information is recognized.

18. The method of claim 13, wherein the recognizing of the touch information includes:
recognizing the touch information as third touch information when the number of touches is 5 and the touch time duration is equal to or greater than a set time duration.

19. The method of claim 18, wherein the forming of the deformed manipulation portions includes:
protruding a surface region of the touch display corresponding to an interior of a circle whose diameter is a line passing through two farthest points among the five touch coordinates to form a hemispherical deformed manipulation portion on a surface of the touch display when the third touch information is recognized.

20. The method of claim 11, further comprising:
implementing a graphic user interface (GUI) based on a shape of the deformed manipulation portion on the touch display.
